(19) United States
(12) Patent Application Publication
(10) Pub. No.: US 2024/0399357 A1
(43) Pub. Date: Dec. 5, 2024

(54) REAGENT STORAGE SYSTEM

(71) Applicant: Tecan Genomics, Inc., Redwood City, CA (US)

(72) Inventor: Douglas A. Amorese, Los Altos, CA (US)

(21) Appl. No.: 18/783,860

(22) Filed: Jul. 25, 2024

Related U.S. Application Data
(63) Continuation of application No. 17/165,435, filed on Feb. 2, 2021, now Pat. No. 12,059,674.
(60) Provisional application No. 62/969,364, filed on Feb. 3, 2020.

(51) Int. Cl. B01L 3/02; G01N 35/10

(52) U.S. Cl. CPC B01L 3/0217; G01N 35/1002; B01L 2200/0689; B01L 2200/142; B01L 2200/16

(57) ABSTRACT

A small volume aqueous sample followed by an air gap and a droplet of oil can be drawn into a pipette tip as a means of storing and protecting the sample from the environment for extended periods of time.

### TECHNICAL FIELD

The disclosure relates to reagent and reaction storage.

### BACKGROUND

Many analytical techniques require the use of precise, and sometimes small, amounts of reagent. In molecular biology for example, reactions are often conducted in microfluidic environments and several reagents must be combined in precise amounts and ratios to ensure an acceptable result. Furthermore, many reactions are sensitive to contamination and reagents must therefore be stored and manipulated in a controlled environment. Various attempts to automate reagent delivery can remove some human error but come with their own shortcomings.

Existing methods of automated reagent delivery include robotic fluid handlers and microfluidic devices. The advent of automated reaction processing in computer-controlled systems allows for round-the-clock experimentation. Unfortunately, with automated reactions being completed late at night and on weekends, they may be left unattended for hours or days at a time until a researcher returns to the laboratory. While the samples await retrieval, reaction volume may be lost to evaporation or may experience other environmental degradation that can impact results and ruin the experiments.

Controlling evaporation and environmental degradation of these samples is critical. Sealing systems exist to apply a seal to the vessel containing the finished sample but these sealing systems add cost and complexity to the liquid handler and can interfere with access to the sample being processed. Small volumes with large surface areas, even in sealed enclosures can be subject to evaporation over time. When these samples are in open containers, evaporation takes place even more rapidly depending on the operating environment (relative humidity and airflow).

### SUMMARY

Systems and methods of the invention provide sample storage in commonly-used liquid reaction processing components (e.g., pipette tips) that avoid evaporation and environmental degradation of reaction volumes therein. By containing reaction volumes in pipette tips, processing can be simplified and expensive consumables can be conserved, saving time and money. In order to store a liquid sample, a small amount of another fluid can be drawn into the end of the pipette to separate the sample from the external environment. Due to the function of the pipette, one end of the tip is already sealed against the pipette itself while liquid is drawn in through an opposite open end. By drawing a scaling fluid into the open end, the sample volume can then be fully sealed within the pipette tip, avoiding evaporation and other forms of environmental degradation. The sealing fluid may be immiscible with the sample in order to prevent mixing. For example, where the sample is aqueous, the sealing fluid may be an oil such as mineral oil. The sealing fluid may be inert or otherwise non-reactive with the sample in order to avoid any impact on the reaction in the stored sample. A pipette tip may be a disposable tip made of polymer (e.g. polypropylene, polypropylene with graphite) for manual pipettes or for automated systems. A pipette tip may also be a cannula made of stainless steel coated with fluoropolymer or not for automated processing systems.

In certain embodiments, a small amount of air can be drawn into the pipette tip before the sealing fluid to provide a separation between the sealing fluid and the sample volume. The resulting air gap between the sample and the sealing fluid can prevent the sealing fluid from migrating above or trading positions with the sample volume which would effectively break the seal. In some embodiments, the sealing fluid may have a greater density than the sample and the pipette may be stored in an upright manner such that the tip opening is the lowest point and the more dense sealing fluid remains between the sample and the opening. Systems and methods of the invention may be used whenever reagents or reaction volumes might be stored, such as upon completion of a reaction or at a stopping point in the reaction. In certain embodiments, incubations or other longer-running steps in an experiment may be performed in a pipette tip sealed according to methods of the invention.

Methods of the invention may be performed manually or in automated fluid-handling machines. In certain embodiments, automated fluid handling devices may be controlled by a computer including a non-transitory memory and a processor. The computer may be operable to perform the steps of the method to store a sample at the end of a reaction. The computer may initiate the sealing steps of the methods described herein upon receipt of a user command to pause the reaction. Such a command may be received via a user interface. In certain embodiments, the computer may be programmed to, upon completion of a reaction or while awaiting additional user input, automatically seal the pipette tip until the user is ready to resume the reaction or retrieve the sample. Automated machines may include a reservoir of sealing fluid in order to perform the sealing steps.

Aspects of the invention include sample storage methods. The methods may include providing a sample in a pipette tip attached to a pipette and drawing air though an opening in the pipette tip using the pipette to create an air gap between the sample and the opening. Methods may then include drawing a fluid into the opening using the pipette to seal the opening and prevent evaporation of the sample.

The fluid may be immiscible with the sample. In various embodiments, the sample can be aqueous and the fluid may be an oil. The fluid may comprise mineral oil. In certain embodiments the fluid may be a wax and methods may include storing the pipette tip at a temperature below the melting point of the wax and heating the wax above its melting point in order to remove the sample from storage in the tip. In certain embodiments, the air gap can separate the fluid from the sample. Methods may include storing the sample in the pipette tip without evaporation for at least one hour, at least 6 hours, at least 12 hours, at least 24 hours, at least 2 days, or at least 3 days.

In some embodiments, the pipette may be part of an automated processing system. The automated processing system can include a non-transitory memory in communication with a processor operable to perform steps of a reaction using the pipette. The automated processing system may be operable to perform the drawing steps upon completion of the reaction. The automated processing system can be operable to perform the drawing steps upon receipt of a user input pausing the reaction.

In certain aspects, systems of the invention may include an automated processing system including a computer and pipette and operable to perform the methods described herein.

### BRIEF DESCRIPTION OF THE DRAWINGS

FIG. 1 shows pipette-tip storage according to certain embodiments.

FIG. 2 shows pipette-tip storage with a buffer according to certain embodiments.

FIG. 3 diagrams steps of a method of the invention.

FIG. 4 diagrams steps of a method for sample storage with a buffer.

### DETAILED DESCRIPTION

Systems and methods of the invention provide streamlined storage of reagents and samples during or after reactions. By storing said volumes in pipette tips otherwise present and used in reaction processing, the use of complicated sealing systems and excessive consumables can be avoided. Because the samples are sealed within the pipette tip, problems resulting from the evaporation or environmental degradation of the sample can be avoided. Accordingly, in automated processes that reach stopping points during weekends or other off-hours, samples can be safely stored within pipette tips by the system for hours or days until a researcher or other user can attend to them.

The pipette tip avoids much of the evaporation and degradation issues arising from environmental exposure due to the relatively small cross-sectional area exposed to the environment through the pipette tip's opening. Even so, systems and methods of the invention include drawing a scaling fluid into the pipette tip opening to form a buffer between the sample or reaction volume and the outside environment.

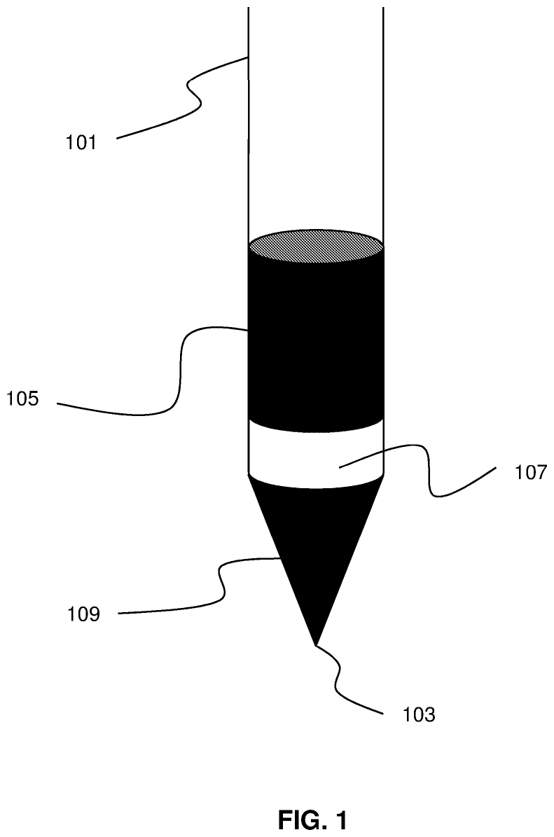

FIG. 1 shows a sample volume 105 being stored in a pipette tip 101 according to certain embodiments. The pipette tip 101 comprises an opening 103 through which fluid can be drawn into the pipette tip 101 in response to changes in pressure or volume within the pipette (not shown). The pipette tip 101 can be a disposable tip including a larger opening which is scaled to a pipette (not shown) such as those commercially available from Tecan Trading, Ltd. (Switzerland). In certain embodiments the pipette tip 101 may be integrated into a pipette comprising, for example, a deformable bulb used to draw fluid into and expel fluid from the tip 101. Pipettes and pipette tips 101 may be part of an automated fluid handling system such as the Fluent and Freedom EVO platform available from Tecan Trading, Ltd. (Switzerland).

When storage of the sample volume 105 is desired, the pipette can be used to draw air into the pipette tip 101 to form an air gap 107 before drawing a sealing fluid 109 into the pipette tip 101. The sealing fluid 109 can be immiscible with the sample volume 105 to prevent mixing should they come in contact. The air gap 107 can help prevent any such contact and help maintain the positions of the sample volume 105 and the sealing fluid 109 relative to the opening 103 thereby maintaining a sealed environment for the sample volume to prevent evaporation or environmental degradation.

In preferred embodiments, the sample volume 105 is aqueous, such as a DNA library that has been prepared for sequencing. In such embodiments, the sealing fluid 109 may be an oil such as mineral oil. Exemplary mineral oils include J6292, BP26291, and O121-1 available from ThermoFisher (Waltham, MA) and M5904 BioRcagent and M8662 PCR Reagent available from Sigma-Aldrich (St. Louis, MO). In preferred embodiments, the sealing fluid 109 may be a low-volatility fluid that does not evaporate at room temperature and is accordingly odorless.

In some embodiments, the sealing fluid 109 may be a wax that is drawn into the pipette tip 101 in a liquid state. The pipette tip 101 can then be stored at a temperature below the melting point of the wax and the sealing wax can be heated above its melting point in order to remove the sample volume 105. The sealing fluid 109 is preferably inert or non-reactive with the sample volume 105 such that any incidental contact between the two will not affect reaction results. In order to promote the desired positioning of the sealing fluid 109 between the sample volume 105 and the opening 103, the relative densities of the two fluids and the storage position of the pipette tip 101 may be manipulated. For example, the pipette tip 101 may be stored with the opening 103 facing downward and the scaling fluid 109 may be selected to have a greater density than the sample volume 105.

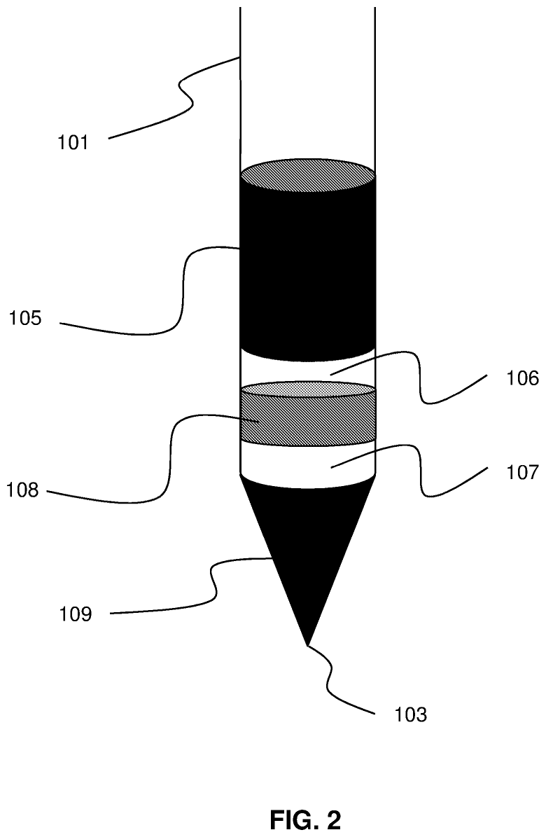

FIG. 2 shows a sample volume 105 and a buffer volume 108 being stored in a pipette tip 101 according to certain embodiments. The pipette tip 101 comprises an opening 103 through which fluid can be drawn into the pipette tip 101 in response to changes in pressure or volume within the pipette (not shown) in a manner similar to that described with respect to FIG. 1. However, an additional buffer volume 108 is draw in to the pipette tip 101 and is separated from the sample volume 105 and the sealing fluid 109 by two air gaps (106 and 107). The buffer volume 108 may be a solvent in certain embodiments and can have a similar composition to that of the sample volume 105 (e.g., similar pH and ion strength).

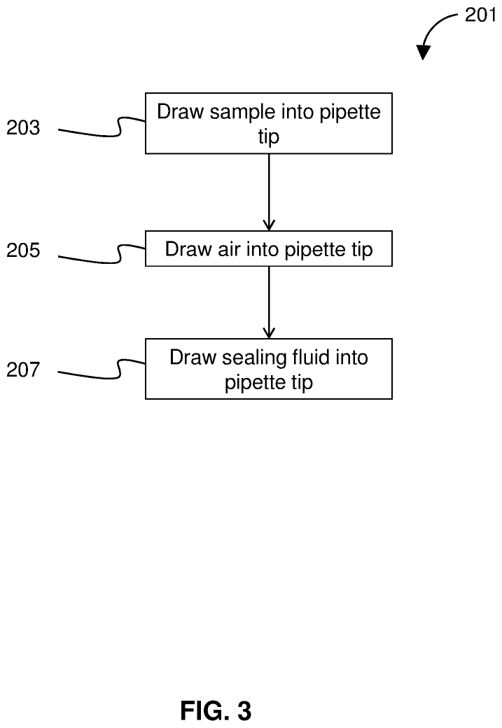

FIG. 3 diagrams steps of an exemplary method 201 of the invention. In order to initiate pipette-tip storage of a sample volume, the sample is first drawn into the pipette tip 203 through the tip's opening using the pipette. As noted, the pipette may be manually operated or may be part of an automated system. Subsequently, air is drawn into the pipette tip 205 to create an air gap between the sample and the opening of the pipette tip. The sealing fluid is then drawn into the pipette tip 207. In manually operated pipettes, a sufficient volume should be selected to accommodate the sample volume to be stored, the air gap, and the sealing fluid.

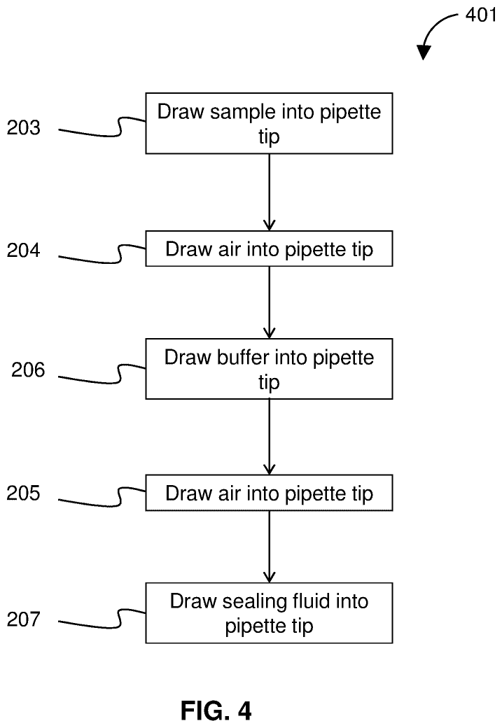

As shown in FIG. 4, in between drawing the sample into the pipette tip 203 and drawing air into the pipette tip 205, a buffer can be drawn in 206. An additional volume of air can be draw in 204 between the sample and the buffer to obtain a sample, air gap, buffer, air gap, scaling fluid arrangement as shown in FIG. 2.

Automated systems such as those available from Tecan Trading AG can use pipettes to automatically distribute precise volumes of sample and reagents between reservoirs and reaction vessels. Accordingly, such systems already include pipette tips and are operable to manipulate them for fluid handling purposes. Such systems are used to perform any variety of reactions including genomic applications and cell-based assays. In-pipette-tip storage may be programmed into any assay depending on the specific requirements of the reactions included therein. For example, during longer periods of incubation, pipette-tip storage as described herein may be used to avoid evaporation or sample degradation during incubation. Sample storage steps may be programmed into the automated system as a default last step upon completion of the assay or other reaction. Accordingly, if an automated reaction is completed over a weekend or after-hours, the reaction is safely stored until a user can retrieve the sample for analysis, long-term storage, or other subsequent processing.

Where the nature of the assay allows for it, automated systems may provide an option to pause the assay via a user interface such that a user can indicate a desire to pause the reaction and, upon reaching the next opportunity in the assay (e.g., where the reaction is not time-sensitive) the in-pipette-tip storage methods described herein may be applied. In certain embodiments, the temperature of the samples stored in pipette tips may be manipulated via heaters or refrigerators within the automated system to aid in incubation or to promote stability of the sample being stored. Such systems may comprise enclosures in which the pipetting operations and, potentially, sample storage may be performed. In certain embodiments, systems may include means of disinfecting the interior of the enclosure to avoid sample contamination. For example, systems may be operable to release disinfecting gas into the enclosure and/or to generate a disinfecting gas such as ozone gas through a variety of known methods. Disinfection can be accomplished through any method including through the application of a disinfecting energy such as light (e.g. ultraviolet) or heat.

Systems and methods of the invention may be modified such that, instead of drawing a sealing fluid into the pipette tip, the opening of the pipette tip may be submerged in a reservoir of fluid to effectively seal the pipette tip and prevent evaporation of its contents. The reservoir may contain any of the fluids discussed above as potential sealing fluids including various mineral oils or even waxes. Sealing the pipette tip through submersion is also compatible with the use of air gaps and buffer fluid(s) as discussed above and such embodiments are contemplated.

In various embodiments, when retrieval of the sample volume is desired, the sealing fluid and sample may be released. During storage, an automated system may precisely manage and record the volumes of air and sealing fluid taken into the pipette tip and may then use that information to discard the exact amount of sealing fluid used into a waste receptacle before distributing the sample for further processing or analysis. The air gap may provide a buffer useful in evacuating the sealing fluid without accidentally discarding any of the sample volume.

In certain embodiments, the buffer and sealing fluid may be discarded in a single dispensing action. The buffer may serve to wash away traces of sealing fluid as it is dispensed from the tip to avoid potential contamination of the sample with sealing fluid.

Samples stored in pipette tips using the methods described herein may be stored without measurable evaporation for more than 1 hour, 2 hours, 6 hours, 12 hours, 24 hours, 2 days, 3 days, 4 days, or 5 days.

As one skilled in the art would recognize as necessary or best-suited for the systems and methods of the invention, systems and methods of the invention may include one or more servers and/or computing devices that may include one or more of processor (e.g., a central processing unit (CPU), a graphics processing unit (GPU), etc.), computer-readable storage device (e.g., main memory, static memory, etc.), or combinations thereof which communicate with each other via a bus. Computer systems may be integrated into or in communication with automated processing systems of the invention and may be operable to control one or more pipettes therein and perform the methods described above.

A processor may include any suitable processor known in the art, such as the processor sold under the trademark XEON E7 by Intel (Santa Clara, CA) or the processor sold under the trademark OPTERON 6200 by AMD (Sunnyvale, CA).

Memory preferably includes at least one tangible, non-transitory medium capable of storing: one or more sets of instructions executable to cause the system to perform functions described herein (e.g., software embodying any methodology or function found herein); data; or both. While the computer-readable storage device can in an exemplary embodiment be a single medium, the term “computer-readable storage device” should be taken to include a single medium or multiple media (e.g., a centralized or distributed database, and/or associated caches and servers) that store the instructions or data. The term “computer-readable storage device” shall accordingly be taken to include, without limit, solid-state memories (e.g., subscriber identity module (SIM) card, secure digital card (SD card), micro SD card, or solid-state drive (SSD)), optical and magnetic media, hard drives, disk drives, and any other tangible storage media.

Any suitable services can be used for storage such as, for example, Amazon Web Services, memory of server, cloud storage, another server, or other computer-readable storage. Cloud storage may refer to a data storage scheme wherein data is stored in logical pools and the physical storage may span across multiple servers and multiple locations. Storage may be owned and managed by a hosting company. Preferably, storage is used to store instructions as needed to perform and support operations described herein.

Input/output devices according to the invention may include one or more of a video display unit (e.g., a liquid crystal display (LCD) or a cathode ray tube (CRT) monitor), an alphanumeric input device (e.g., a keyboard), a cursor control device (e.g., a mouse or trackpad), a disk drive unit, a signal generation device (e.g., a speaker), a touchscreen, a button, an accelerometer, a microphone, a cellular radio frequency antenna, a network interface device, which can be, for example, a network interface card (NIC), Wi-Fi card, or cellular modem, or any combination thereof. Input/output devices such as user interfaces may be used to provide information regarding reaction status and to receive instructions including reaction holds that the computer may interpret as instructions to perform the on-pipette storage methods described herein.

One of skill in the art will recognize that any suitable development environment or programming language may be employed to allow the operability described herein for various systems and methods of the invention. For example, systems and methods herein can be implemented using Perl, Python, C++, C#, Java, JavaScript, Visual Basic, Ruby on Rails, Groovy and Grails, or any other suitable tool.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A sample storage method comprising:
providing a sample in a pipette tip attached to a pipette;
drawing air though an opening in the pipette tip using the pipette to create an air gap between the sample and the opening;
drawing a fluid into the opening using the pipette to seal the opening and prevent evaporation of the sample.

2. The method of claim 1 wherein the fluid is immiscible with the sample.

3. The method of claim 1 wherein the fluid does not evaporate at room temperature.

4. The method of claim 1 wherein the fluid is a solid at room temperature.

5. The method of claim 2 wherein the sample is aqueous and the fluid is an oil.

6. The method of claim 5 wherein the fluid comprises mineral oil.

7. The method of claim 1 wherein the air gap separates the fluid from the sample.

8. The method of claim 1 further comprising storing the sample in the pipette tip without evaporation for at least one hour.

9. The method of claim 8 further comprising storing the sample in the pipette tip without evaporation for at least 6 hours.

10. The method of claim 9 further comprising storing the sample in the pipette tip without evaporation for at least 12 hours.

11. The method of claim 10 further comprising storing the sample in the pipette tip without evaporation for at least 24 hours.

12. The method of claim 11 further comprising storing the sample in the pipette tip without evaporation for at least 2 days.

13. The method of claim 12 further comprising storing the sample in the pipette tip without evaporation for at least 3 days.

14. The method of claim 1 wherein the pipette is part of an automated processing system.

15. The method of claim 14 wherein the automated processing system comprises a non-transitory memory in communication with a processor operable to perform steps of a reaction using the pipette.

16. The method of claim 15 wherein the automated processing system is operable to perform the drawing steps upon completion of the reaction.

17. The method of claim 15 wherein the automated processing system is operable to perform the drawing steps upon receipt of a user input pausing the reaction.

18. The method of claim 15 wherein the automated processing system is operable to dispense the sample upon receipt of a user input to dispense the stored sample.

19. The method of claim 1 further comprising:
storing the pipette tip with sealed opening in an enclosure; and
disinfecting the enclosure.

20. The method of claim 19 wherein disinfecting is performed using a disinfecting gas.

21. The method of claim 20 wherein the disinfecting gas is an ozone gas.

22. The method of claim 19 wherein disinfecting is performed using a disinfecting energy source.

23. The method of claim 22 wherein the energy is ultraviolet light.

24. The method of claim 23 wherein the pipette tip blocks ultraviolet light.

25. The method of claim 22 wherein the energy is thermal energy.

26. A sample storage method comprising:
providing a sample in a pipette tip attached to a pipette;
drawing air though an opening in the pipette tip using the pipette to create an air gap between the sample and the opening;
submerging the opening in a reservoir containing a fluid to seal the opening and prevent evaporation of the sample.

27. The sample storage method of claim 26 wherein the fluid is immiscible with the sample.

28. The sample storage method of claim 27 wherein the sample is aqueous and the fluid is an oil.

29. The sample storage method of claim 28 wherein the fluid comprises mineral oil.

30. The sample storage method of claim 26 wherein the air gap separates the fluid from the sample.
